(19) United States
(12) Patent Application Publication
(10) Pub. No.: US 2004/0075734 A1
(43) Pub. Date: Apr. 22, 2004

(54) Stereo 3D Viewer

(76) Inventors: Vincent E. Robinson, San Jose, CA (US); Lawrence J. Simpson, Fremont, CA (US); Jeffrey K. Fergason, Menlo Park, CA (US)

Correspondence Address: Warren A. Sklar, Esq., Renner, Otto, Boisselle & Sklar, LLP, Nineteenth Floor, 1621 Euclid Avenue, Cleveland, OH, 44115, US

(21) Appl. No.: 10/395,026

(22) Filed: Mar. 21, 2003

Related U.S. Application Data
(60) Provisional application No. 60/366,824, filed on Mar. 22, 2002.

(51) Int. Cl. H04N 13/00; H04N 15/00

(52) U.S. Cl. 348/42; 348/51

(57) ABSTRACT

A stereo three dimensional (3D) viewer system displays images in stereoscopic 3D. The stereo 3D viewer system includes a stereo 3D viewer component with a first user interface and a viewer stand-alone application with a second user interface. The stereo 3D viewer component provides a viewing window for the display of 3D images, and the first user interface provides means for controlling the display in the stereo 3D viewer viewing window. The viewer stand-alone application provides a user-interface wrapper for the stereo 3D viewer. The second user interface provides a menu with commands for controlling the presentation of the 3D images via the viewer stand-alone application.

This application claims the benefit of U.S. Provisional Application No. 60/366,824, filed Mar. 22, 2002.

### TECHNICAL FIELD

This invention relates generally to apparatus and method for displaying images and viewing as three dimensional (3D) or stereoscopic images, and, more particularly, to apparatus and method that will accept various formats of 3D video input and output various formats of 3D images for viewing.

### BACKGROUND

Viewing 3 dimensional images on personal computer systems in a variety of formats including 3D photos, 3D artwork, 3D animations, 3D movies and 3D interactive games is highly desirable. However, the display of the full variety of the aforementioned image types on a single computer presents particular challenges, such as the following:

Each image type generally requires unique software to facilitate the creation and/or display of that specific image type.

There are at least three unique techniques used to format stereoscopic 3D images including interlaced, above-below and frame sequential, and display and viewing systems usually are specialized to accommodate only one of those formats.

Each of the unique 3D image formats has different computer system capability and capacity requirements. Therefore, not all computers can display all 3D image formats.

The display of 3D images requires different computer resources than the display of 2D images. Therefore, it would be highly desirable to create a software system that can enable the computer system to seamlessly switch between 2D and 3D display modes, and to switch between each of the display techniques.

The viewer described below with appropriate operating software addresses these challenges. As will be appreciated, the viewing of 3D images usually requires a sequence of images to be provided to the left and right eyes of a person who views the 3D images. Images intended for the left eye and those for the right eye are in effect perceived or viewed from a different perspective or angle and when integrated by the human brain provide the impression of 3D or stereoscopic image. The respective left and right eye images may be provided to the eyes of a person who views the images by a series of such images presented on a display while respective shutters, eye glass lenses or the like allow the left eye image to be viewed by the left eye and the right eye images to be viewed by the right eye. In an alternate system for viewing 3D images, the images may be provided to small displays, such as virtual reality type displays, goggles, or the like, that are able to present respective left and right eye images directly to a person's eyes. Also, if desired, a polarization changing shutter may be provided for a display (or the display may be a liquid crystal display with an appropriate arrangement, to differentiate by polarization characteristics of light the left and right eye images; and such images can be viewed selectively via polarizing filters worn over the viewer's eyes. Exemplary displays useful to provide images of any of the types described here may be liquid crystal displays, cathode ray tube displays, plasma displays, or virtually any other display.

### SUMMARY

According to an aspect of the present invention a stereo 3D viewer (“viewer”) includes a software application that displays images and videos in stereoscopic 3D.

According to an aspect, a stereo 3D viewer simplifies the software complexity of multifunctional 3D viewing systems and simplifies the ease of use of a 3D viewing system.

According to another aspect the viewer application includes an executable with a COM interface where the application is either downloaded or delivered via CD.

According to another aspect, once the viewer is installed on a personal computer, stereoscopic 3D content either can be viewed with the stand-alone application or, when a web page with embedded content is shown, the viewer displays the image or movie within the page.

According to another aspect, image and video file formats displayed by the viewer are industry standard formats; no proprietary formats are needed. Exemplary stereo formats supported include page flip and interlaced and others.

According to another aspect a Netscape plug-in wrapper adds support to enable use of the software application using Netscape Navigator.

According to another aspect the viewer may be a default viewer for all stereoscopic 3D content. This content can be local such as a DVD, Video CD, video, image, or vector file on a hard drive. Content can also be located remotely like a video, image or vector file on a networked server or streaming media server.

One or more of the above and other aspects, objects, features and advantages of the present invention are accomplished using the invention described and claimed below.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

Although the invention is shown and described with respect to certain embodiments, it is understood that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

In the annexed drawing:

The sole FIGURE is a schematic illustration of the components of the invention.

### DESCRIPTION

### Overview

The Stereo 3D Viewer (“Viewer”) is a software application that displays images and videos in stereoscopic 3D. The application consists of an executable with a COM interface where the application is either downloaded or delivered via CD. Once the Viewer is installed on a personal computer, stereoscopic 3D content can either be viewed with the stand-alone application or, when a web page with embedded content is shown, the viewer displays the image or movie within the page. The image and video file formats displayed by the viewer are industry standard formats; no proprietary formats are needed. The stereo formats supported will be ones technically possible such as page flip and interlaced. A Netscape plug-in wrapper also adds support for Netscape Navigator.

The Viewer is a default viewer for all stereoscopic 3D content. This content can be local such as a DVD, Video CD, video, image, or vector file on a hard drive. Content can also be located remotely like a video, image or vector file on a networked server or streaming media server.

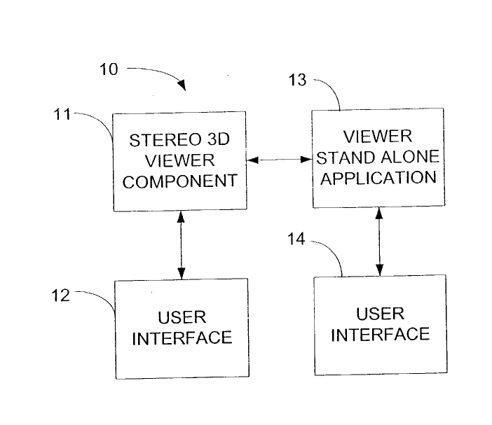

Referring, now, to the drawings, wherein like reference numerals designate like parts in the several figures, and initially to FIG. 1, a stereo 3D viewer system in accordance with the present invention is generally shown at 10.

The stereo 3D viewer system includes a stereo 3D viewer component 11 with a user interface 12 and a viewer stand-alone application 13 with a user interface 14.

As will be described further below, the stereo 3D viewer system 10 supports various video and image formats. The stereo 3D viewer system 10 also is capable of operating in a windowed mode and/or in a full screen mode.

The Viewer includes three software components. The first two are incorporated into the same executable and the third is a dynamic link library and a Java class for Netscape support. A description of the Viewer follows:

1.1 Stereo 3D Viewer Component

This is the COM object that contains the viewing window. This object will contain the DirectX 8.1 DirectShow and QuickTime libraries for video support and an image format library for image import support. Once the image/video frame buffer has been filled the stereo 3D viewer component will divide the image/video buffer into a left eye view and right eye view and will display the image/video frame in the selected stereo format chosen.

1.1.1 User Interface

There is the view window and two methods of input for this object.

The first is a right-click pop-up menu, which contains the following functions:

Play/Pause

Stop

Rewind

Fast Forward

Stereo (Check Box)

Repeat (Check Box)

Properties

Display Options

About

Full-screen

If selected, the Play/Pause function provides a signal to cause the movie to play or a given image to be displayed; alternatively, if selected a second time the movie or image is paused.

If selected, the Stop function provides a signal to cause the movie to stop playing.

If selected, the Rewind function rewinds the movie a prescribed amount or, if desired back to the beginning.

If selected, the Fast Forward function fast forwards the movie to another location in the movie or, if a slide show or series of images is being shown, moves forward to another of those slides or images.

If selected, the Stereo function causes the movie to be played or an image to be shown in 3D stereo.

If selected, the Repeat function, which may be provided by a “Check Box” that can be selected or deselected, the movie, image or series of images would repeat after having been completed.

If selected, the Properties function displays the properties of the file containing the movie, still images, or the like.

If selected, the Display Options function allows the user to select various display options.

If selected, the About function provides information about the program, such as the author, copyright holder, version, and/or other pertinent information.

If selected, the Full-screen function allows the image to be displayed on the full screen of the computer as compared to in a window or small section of the screen.

The second input option is a viewing toolbar, which is attached to the viewing window. The toolbar is optional based on whether it is embedded on a web page (in which case the page author can disable this feature or function) or within the stand-alone application (it is only visible when a video is displayed). This toolbar contains icons that relate to the following commands, the functions of which are evident from the terms just below:

Play/Pause

Stop

Clip Position Bar (if video).

1.2 Viewer Stand-Alone Application

The application is essentially a user-interface wrapper of the Stereo 3D Viewer Object. The application is a standard Windows application that has a resizable window, menu and client area. As the window is resized, proper stereo alignment shall be maintained.

1.2.1 User-Interface

The application contains everything from 2.1.1 as well as a menu. The menu has four headings: File, View, Play and Help, each with their own commands. These commands, which may be icons displayed on a screen, may be drop down menus or may be otherwise shown and/or selected, are included below:

The File Menu has the following functions that can be selected:

Open

Close

Properties . . .

Preferences . . .

Exit

The View Menu has the following functions that can be selected:

Full Screen

Stereo (Check Box)

Repeat (Check Box)

The Play Menu has the following functions that can be selected:

Play/Pause

Stop

Rewind

Fast Forward

The Help Menu has the following functions that can be selected:

Help Topics . . .

About . . .

1.3 Netscape Wrapper

The Netscape wrapper is a dynamic link library that is placed in the Netscape/Plugins directory. Netscape does not support COM objects directly. The Stereo Viewer object is called when the <OBJECT><EMBED> tag combination for the viewer is found.

An additional Java interface is needed for JavaScript commands used by page authors.

2.0 Supported Video and Image Formats

The invention supports several video file formats, for example, as follows:

Motion Picture Experts Group (MPEG)

Audio-Video Interleaved (AVI)

QuickTime Movie

Digital Video Format

The invention supports several compression formats, for example, as follows:

MPEG Audio Layer-3 (MP3) (decompression only)

Digital Video (DV)

MPEG-1

MJPEG

Indeo

Cinepak

MPEG-2 (may require 3^{rd} party product)

H.261

H.263

Apple Video

Component video

DV NTSC and PAL From Internal DVD Drive

Microsoft OLE

Motion JPEG A and B

Planar RGB

Sorenson Video 1, 2, and 3

The invention supports several image formats, for example, as follows:

JPEG/JIF files

JPS files

PNG files

BMP files

GIF files (a license may be needed for this support)

PhotoShop files

TARGA files

TIFF files

3.0 Stereo Formats Supported

Both windowed and full screen stereo formats are supported.

3.1 Windowed

The viewer will support interlaced, page-flipping, and anaglyph stereo in windowed mode.

3.2 Full Screen

Full Screen will allow for interlaced, page-flipped, and anaglyph. Tests for different video cards and displays may be conducted.

4.0 Enhancements

The Viewer is designed as a modular software program that can be expanded to include inventive new features such as, for example, the following:

4.1.1 Windows Media SDK Support:

Enables a broader range of standard media authoring tools to be used for creation of stereoscopic 3D images. The following file formats could be covered: Windows Media™ Audio (WMA), Windows Media™ Video (WMV), Advanced Streaming Format (ASF). The following Compression formats could be covered: Microsoft Windows Media Video codec version 7.0, ISO MPEG-4 video version 1.0, Microsoft MPEG-4 version 3, Sipro Labs ACELP, Windows Media Audio, Voxware.

4.1.2 Slide Show:

Enables individual 3D images to be group together for a continuous presentation.

4.1.3 2D to 3D Video Image Conversion:

Coverts 3D video files from standard 2D format to stereoscopic 3D format.

4.1.4 Interlaced 3D Software Viewer:

Enables 3D stereoscopic interlaced format images to be viewed very low cost page flipping glasses.

What is claimed is:

1. A system for displaying three dimensional (3D) images, comprising
an input device for receiving 3D video inputs, and an output device for outputting 3D images for viewing.

2. A system as set forth in claim 1, wherein the video input is in at least one of the following formats: interlaced format, above-below format and frame sequential format.

3. A method for displaying three dimensional (3D) images, comprising
receiving 3D video inputs, and
outputting 3D images for viewing.
